(19) United States
(12) Patent Application Publication
(10) Pub. No.: US 2017/0364896 A1
(43) Pub. Date: Dec. 21, 2017

(54) COMMODITY PURCHASE SYSTEM

(71) Applicant: Michael A. Racusin, Chicago, IL (US)

(72) Inventor: Michael A. Racusin, Chicago, IL (US)

(21) Appl. No.: 15/184,083

(22) Filed: Jun. 16, 2016

(51) Int. Cl. G06Q 20/28; G06Q 20/20; G06Q 20/26; G06Q 30/02

(52) U.S. Cl. CPC G06Q 20/28; G06Q 30/0207; G06Q 20/202; G06Q 20/26

(57) ABSTRACT

A commodity purchase system is disclosed that allows a consumer to pre-purchase a commodity at a discounted price without taking delivery at the time of the purchase. The discount takes into account the unit regional wholesale gasoline price for the region at the time of purchase as well as local taxes and local fees which can vary in different locales. In this way, a wholesaler can offer a commodity purchase card with or without a discount that can be used in all regions of a geographical area, such as the US, even though the local taxes, local fees and the regional unit gasoline price varies. The commodity purchase system allows a purchaser to purchase a commodity that is attractive to wholesalers without any geographical constraints.

### BACKGROUND OF THE INVENTION

### 1. Field of the Invention

The present system relates to a prepaid commodity purchase system for purchase of a commodity, such as gasoline , and delivery of the commodity at a later time, for example, at retail gasoline stations and a method for selling such commodities that allows a purchaser to pre-purchase a commodity, such as gasoline, at a discount or no discount without any constraints on the location of delivery because the system automatically adjusts the retail price as a function of the location.

### 2. Description of the Prior Art

Various systems and methods are known for purchasing commodities at a discount. In general, these systems allow consumers to pre-purchase a predetermined amount of a commodity, such as fuel, at a discounted price. Examples of such systems are disclosed in Canadian published patent application no. CA 2,684,118 A; Korean published patent application no. KR 2002-00074964 A; U.S. Pat. Nos. 7,742,942; 8,504,465 and US Published Patent Application Nos.: US 2006/086787 A1 and US 2007/0276738. A system for purchasing discounted commodities is also disclosed in the literature: “Portland Fixed Price Fuel Card”; www.poprtland-fuelcard.co-uk/.

Canadian published patent application no. CA 2,684,118 A discloses a system for providing discounted fuel cards that allow consumers to purchase fuel at a discounted price. In this system, a third party negotiates a discount with a fuel supplier. The third party allocates a portion of the discount to the retail fuel vendor with the balance of the discount is allocated to the consumer.

For example, assume a normal pump price per gallon of $3.00 per gallon and the third party negotiates a discount of $0.50 per gallon. Further assume that the third party allocates $0.10 per gallon as profit and $0.05 per gallon for the retail fuel vendor. In this example, the consumer would pay a discounted price of $2.65 per gallon with an extra $0.05 per gallon going to the retail fuel vendor and $0.10 per gallon going to the third party.

Korean published patent application no. KR 2002-00074964 A discloses another discount system discloses a system in which consumers can obtain a membership card and purchase commodities from predetermined manufacturers from predetermined stores upon presentation of the discount membership card.

U.S. Pat. No. 7,742,942 discloses yet another type of discount system. A discounted price per unit for fuel is associated with a certain credit card. When a consumer purchases fuel with the certain credit card, the system automatically identifies the certain credit card and applies the discounted price per unit for the fuel being purchased.

US Patent Application Publication No. 2006/0086787 A1 discloses a discount system associated with the sale of aviation fuel. In this system, consumers, i.e. pilots, that qualify for a discount are registered in a database. In this system, fuel is purchased at an airport and paid for by the pilot with a credit card at a point of sale (POS) terminal. The POS terminal is connected to a network that includes a database. Once the pilot swipes their credit card at the POS, the system automatically checks whether the purchaser is registered in the database for a discount. If so, the credit card is debited at the discounted price. If the purchaser is not registered for a discount, the credit card is debited for the full purchase price.

US Patent Application Publication No. 2007/0276738 A1 a system that allows consumers to prepay for a specified amount of fuel at a discounted price. The consumer is issued a magnetic card that allows the consumer to purchase the specified amount of fuel at the discounted price at various merchants at a later time. In this system, the purchaser is issued a magnetic card that is similar to a conventional credit card. The magnetic card enables the purchaser to purchase fuel at a discounted price. The non-patent literature, “Portland Fixed Price Fuel Card”, as discussed above, similarly offers a prepaid magnetic card for purchasing fuel at a discounted price.

Other known commodity purchase systems are similar to a type of security known as an option. For example, U.S. Pat. No. 8,504,465, assigned to Goldman Sachs, discloses an option based discount system for the purchase of fuel. In this system, the consumer purchases an option to purchase fuel at a predetermined strike price, i.e. discount price. The strike price is normally less than a premium price, i.e., retail price. As long as the consumer satisfies a predetermined usage restriction, the consumer can redeem the difference between the retail price paid for fuel purchased and the strike price for purchases in which the actual purchase price exceeds the strike price.

Other systems are known which provide price protection associated with the purchase of a commodity, such as fuel. Examples of these systems are disclosed in U.S. Pat. Nos. 8,019,694; 8,065,218; 8,086,517; 8,156,022; and 8,160,952. These patents all relate price protection contracts.

The '218 patent relates to an insurance policy. In this system, the consumer pays an insurance premium in connection with a strike price for a commodity. In this system, the consumer is reimbursed for any amount paid for the insured commodity that exceeds the strike price.

The '694; '517; '022 and the '952 patents all disclose price protection contracts. In general, these price protection contracts are similar to the insurance protection and protect a consumer from price fluctuations of a retail commodity, such as fuel. Several of the disclosed price protection contracts impose constraints on the consumer. For example, the '517 patent discloses price protection contract which requires the consumer to purchase a specified quantity of fuel from a specified locale during a specified time period. The '694 and '022 patents also disclose price protection contracts which require a consumer to purchase the commodity, i.e. fuel, at a specified locale.

Due to price variances of retail commodities at different locales, some of the commodity discount systems restrict discounts to specific locales. One reason for the differences of commodity prices is that add-on charges to the price of the commodity vary by locale. Various state and local taxes are added to the price of each gallon of gasoline. For example, in the city of Chicago, a snapshot of state and local taxes per gallon of gasoline is as follows:
Cook County and Chicago sales tax—11.02
Illinois State Sales Tax—19.68
Illinois Environmental Tax—1.1
Cook County and Chicago Motor Fuel Tax—11.0
Illinois Motor Fuel Tax—19.0
Federal Motor Fuel Tax 18.4

All of the various taxes mentioned above except for the Federal Motor Fuel Tax will vary from locale to locale. Different locales will likely have different taxes and add include other charges based upon the locale, such as delivery charges for the delivery of the gasoline to the gas station. As an example, a snapshot of recent taxes per gallon of gasoline sold in New York City is as follows:
Federal Motor Fuel Tax—18.4
State Petroleum Business Tax—17.8
State Motor Fuel Excise Tax—8
State Petroleum Testing Fee—0.05
State Spill Tax—0.3
State Sales Tax—8
City Sales Tax in MTA region—16.9.

Due to the variance in the local fees, many discount systems are limited to specific geographical areas. For example, U.S. Pat. No. 6,980,960 assigned to Goldman Sachs, discloses an incentive system for fuel purchases. The incentive system is limited to specific geographical areas. U.S. Pat. No. 8,019,694, assigned to Pricelock, Inc., discloses a price protection contract, as discussed above, that is also limited to specific geographical areas. US Patent Application Publication No. 2013/0198074 A relates to a method that allows a consumer to prepay a predetermined number of units of gasoline at one or more predetermined retail gasoline locations in predetermined geographic areas.

In addition to taxes, other factors, influence the price of gas. These factors include distribution and marketing costs, refining costs and crude oil costs. Refining costs and profits vary seasonally and by region in the United States because different gasoline formulations are required to reduce air pollution in different parts of the country. The characteristics of the gasoline produced depend on the type of crude oil that is used and the type of processing technology available at the refinery where it is produced.

Gasoline prices are also affected by the cost of other ingredients that may be blended into the gasoline. For example, because of the volatility of gasoline at relatively high temperatures in the summer season, refineries are required to switch to a “summer blend” in which the gas is less volatile at higher summer temperatures.

Distribution, marketing, and retail dealer costs and dealer profit are also included in the retail price of gasoline. The distribution cost can be relatively significant. In particular, most gasoline is shipped from the refinery first by pipeline to terminals near consuming areas, where it may be blended with other products (such as ethanol) to meet local government and market specifications. Distribution charges include the charges associated with delivering the gasoline by tanker truck to individual gasoline stations. Such delivery charges in New York City are known to amount to 2 cents per gallon of gasoline. As used herein, all such fees as discussed above are hereinafter referred to as local fees.

The most significant cost component in the unit price of gasoline is the price of crude oil. Many factors include the price of crude oil. Crude oil prices are set by the market place based upon commodity trading and the futures and derivative markets. Other factors also influence the cost of crude oil. These factors include: exchange rates and inflation; inventories; weather; OPEC; spare production capacity; and geo-political events. As such, wholesale gasoline is a commodity that is traded on the open market. Its price can change by the minute, which may influence the cost structure for a retailer.

As illustrated in Table 1, the price of crude oil varies by area, which, in turn, affects the unit price of gasoline. Table 1, published by the US Energy Information Administration, illustrates the cost of crude varies substantially by area. Referring to Table 1, in Feb. 16, 2016, for example, the cost of crude varied from $17.38 per barrel in West Virginia to $28.10 in Louisiana. Since the cost of crude is a major component of the cost of gasoline, the price per gallon of gas will vary substantially in different regions.

Based on the above, it is clear that the unit price of gasoline is influenced by many regional factors. These regional factors may be grouped as follows: unit cost of gasoline; local taxes and local fees. The local fees include delivery charges, retail profit and other charges as discussed above.

Based upon the regional factors, so called gasoline discount cards have heretofore not been useful by wholesale distributors, such as the oil companies. However, some discount cards are known which address the issue of the differences in local taxes. For example, Wanasek US Patent Application Publication No. US 2004/0260632 A1 (“the Wanasek publication”) discloses a prepaid commodity system. In that system, a user can pre-purchase gasoline from a wholesaler at the current raw gasoline price, i.e. a price that does not include local taxes The user is issued a commodity card that enables the user to take delivery of the prepaid gasoline at a later time. The currency of the prepaid commodity card is gallons. In order to use the prepaid commodity card at a retail gasoline outlet, the user would need to pay local taxes when the gasoline is dispersed. Since the currency of the commodity card is gallons, a separate credit transaction for payment of the local taxes would be required which would undoubtedly require intervention by an attendant.

There are several problems with the prepaid commodity card disclosed in the Wanasek publication. First the gasoline purchase would require two separate transactions in two different currencies; gallons and dollars. The user would require a separate credit card to pay for the local taxes and local fees. Alternatively, the discount card and delivery system would have to be operational in two different currencies. However, there are no known gasoline Point of Sale (POS) terminals that operate in two currencies; gallons and dollars. If a separate credit card is used, the user would likely need to handle the credit transaction with an attendant. In either case, the ability to dispense the prepaid gasoline would then depend on the available credit of either the credit card or the credit component of the commodity card.

Another problem with the system disclosed in the Wanasek publication is that it does not take into account regional variances in crude oil prices. As illustrated in Table 1, there is a wide variance in crude oil prices in different regions across the US which would have a significant impact on the regional wholesale unit gasoline price. A wholesaler would need to constrain the use of the commodity card to a particular region. For example, if a user purchased a prepaid commodity card in a region where the crude oil price is $17.38 per barrel, say West Virginia, unless the card was geographically constrained, the card could theoretically be used in a region, such as Louisiana where the price per barrel of crude is $28.10 per barrel. Thus, the Wanasek card would need to be constrained to region where the price of crude per barrel would be the same.

Klingle International Publication No. WO 01/16905 discloses yet another prepaid commodity system. In this system, a fuel credit certificate issued which can be used at fuel station. The fuel credit certificate includes cost of fuel and local fees. Here overall fuel price is discounted. By discounting the overall fuel price, the unit fuel price will vary because local taxes cannot be discounted. As such, use of the Klingle card can result in a variable fuel discount which makes this method unattractive to wholesalers.

Thus, there is a need for a prepaid system for commodities, such as gasoline, that is attractive to wholesalers and can be used anywhere.

### SUMMARY OF THE INVENTION

Briefly, a commodity purchase system is disclosed that allows a consumer to pre-purchase a commodity at a discounted wholesale price or a non-discounted price without taking delivery at the time of the purchase. The system takes a snapshot of regional wholesale gasoline prices in the retail sales regions of interest to capture the regional wholesale gas prices at the time of purchase of the commodity card. In embodiments where a discount is provided, the discount is applied to the captured wholesale gas price at the locale where gas will be delivered. In embodiments where the commodity is not discounted, the purchaser is able to purchase gas at a price which incorporates the regional, i.e. captured local wholesale gas price, at the time of purchase of the commodity purchase card. Local taxes and local fees are applied to the discounted and undiscounted regional wholesale gas price. Various methods are contemplated for determining a wholesale discount price at delivery for multiple grades of gasoline, such as, regular (e.g. 87 Octane), mid-range (e.g. 89 Octane) and premium (e.g. 91 octane) and optionally E85 grade.

### DESCRIPTION OF THE DRAWING

These and other advantages of the present invention will be readily understood with reference to the following specification and attached drawing wherein:

FIG. 1 is a block diagram of an exemplary system for implementing the commodity purchase system disclosed herein.

FIG. 2 is an exemplary flow chart for the exemplary system illustrated in FIG. 1.

FIG. 3 is an alternate embodiment of the system illustrated in FIG. 2.

### DETAILED DESCRIPTION

A method for selling commodities for delivery at a later time at a discount and a commodity purchase system is disclosed that allows a consumer to purchase units of a commodity at a discounted unit price or at a price that does not include a discount without taking delivery at the time of the purchase. As described herein, a unit price refers to the price of a commodity, such as gallons or liters. In all embodiments of the system that include a discount, the discount is applied to the regional wholesale unit price at the time of purchase before local taxes and local fees are added in order to determine a regional discounted retail unit price at the time of delivery. In embodiments of the system that do not include a discount, the regional wholesale unit price that is captured at the time the commodity purchase card is purchased is used. As such, the commodity purchase system disclosed herein does not impose any geographical constraints on the purchaser since the discounted unit price is determined in each locale.

Various embodiments of the system and method are disclosed including discounted and undiscounted embodiments. Undiscounted embodiments allow a consumer to lock in wholesale gas prices across an entire region of interest. Both the discounted and undiscounted embodiments are based upon a snapshot of all or some of the regional wholesale gas prices in a region of interest. The snapshot is based upon the wholesale gas price in the various regions at the time the commodity purchase card is purchased. In embodiments that apply a discount, the discount is applied to the captured regional wholesale gas price. In embodiments with no discount, the wholesale gas price at the time of purchase is used in determining the regional, i.e. locale specific, retail price. Local taxes and local fees are added to the discounted or undiscounted regional wholesale gas price to determine the regional retail gas price at the time of delivery.

As used herein, the following definitions apply:
Regional unit wholesale gas price: This is the price that a wholesaler, e.g. gasoline company, sells a unit of a commodity, e.g. gallon of gas, to a retailer that exists at the time of purchase of the commodity card and in one embodiment, the purchase of the commodity.
Regional unit retail gas price: This is the price that a retailer sells a unit of a commodity, e.g. gallon of gas to a customer or purchaser. As used herein, this price is generally the price of a unit of a commodity at the time of delivery of the commodity.
Wholesale unit gas price at the time of purchase: This is a snapshot of all regional wholesale unit gas prices in a region of interest which may include some or all of the retailers in the region of interest at the time of purchase of a commodity card or gasoline.
Local taxes: This applies to all of the local taxes applicable to a specific geographic area.
Local fees: These fees may include various items including; dealer profit, gasoline delivery charges, advertising costs, rent, utilities and other costs.
Time of purchase refers to the time of purchase of the commodity card or gasoline.
Time of delivery is the time at which the commodity is delivered, e.g. the time when the gas is pumped.
Discounted regional unit price: This is the total unit price for a commodity at a particular locale at the time of delivery.
Uniform discounted regional wholesale gas price: This is discounted unit wholesale price for a commodity that is based upon a uniform discount.

The term commodity includes various items that are sold on a per unit basis and upon which local fees are also added on a per unit basis. Examples of such commodities include but are not limited to energy related commodities, such as, gasoline, diesel fuel, airline fuel, natural gas and propane gas. The term “commodity” also includes other commodities that are not energy related, such as wheat corn and soy beans and other commodities. It is also understood that such commodities can include commodities that can be purchased by way of POS terminals as well as commodities that can be purchased by other known payment methods.

There are multiple embodiments of the commodity purchase system. In one embodiment of the commodity purchase system, the purchaser purchases a commodity purchase card for delivery of gasoline at a later time. The commodity purchase card has a fixed cash value. In one aspect, the commodity purchase card is similar to a debit card that allows the purchaser to use the commodity purchase card at a point of sale (POS) terminal in order to take delivery of a desired amount of gasoline at a predetermined discount. The commodity purchase card can be purchased for cash or on-line by multiple payment methods, for example, by way of a credit card, or by way of a smart phone or a PayPal account. In lieu of a credit card, the purchaser may be issued a discount purchase pass with a bar code which can be printed out on line or sent to a smart phone in a similar manner as an airline boarding pass. With such a commodity purchase pass, in order for the purchaser to pay a quantity of the commodity, the bar code is scanned at a POS.

In one embodiment, the system is based upon a cash amount and a fixed quantity of units of the commodity. Since the retail price of gas varies due to local taxes, local fees and regional variances in the wholesale price of gas, the purchaser purchases a specified number units of a commodity at a discount and deposits an agreed amount of cash. For example, in this embodiment, the purchaser can purchase a limit of 250 discounted units of a commodity and deposit $1500 cash. The purchaser's account would be exhausted solely when one or the other of the cash credit being exhausted or the purchaser has purchased 250 units, whichever occurs first. Any unused cash can be credited to the purchaser's account.

In an alternate embodiment, the purchaser can purchase a commodity purchase card or commodity purchase pass for purchase of an unspecified number of units of the commodity for a discounted unit price based upon a fixed cash deposit. For example, assume a purchaser purchases a commodity purchase card or commodity purchase pass for $1000. In this embodiment of the system, assume a purchaser purchases $1000 credit for gas at a discounted or undiscounted snapshot wholesale price of $3.00 per gallon pursuant to a specific region. In embodiments where discounts are employed, no discounts can be applied to either the local taxes or local fees. Thus, if the purchaser purchases gas at a locale where the local tax+local fees are $1.00 per gallon, the purchaser would have the ability to purchase 1000/4 ($3 for gas+$1 for local taxes and local fees) or 250 gallons of gas at that location or other locations where the tax+local fees are $1.00 per gallon. Now assume the purchaser purchases 10 gallons of gas at a locale where the local taxes and local fees are $1.00 per gallon. In this situation, 10 gallons of gas times $3.00 per gallon+10 gallons of gas times $1.00 for local tax+local fees=$40.00. At this point, the purchaser has $960 credit left on the commodity purchase card or discount purchase pass. Now assume that the purchaser goes to a locale to purchase gas where the local taxes and local fees are $0.50 per gallon. Since the wholesale gas price less taxes +local fees is fixed, the purchaser would be able to purchase $960/$3.5 or 274 gallons of gas. In these embodiments, the wholesale gas price may be fixed for the region at the time of purchase of the commodity purchase card or commodity purchase pass.

In another alternate embodiment of the commodity discount system, the purchaser purchases the right to purchase a fixed number of discounted units of the commodity. In this embodiment, the commodity purchase card or commodity purchase pass is tied to a credit account of the purchaser, such as a credit card, debit card or PayPal account in a conventional manner. For example, if a purchaser purchased the right to purchase 300 discounted units of the commodity, these purchases would include the regional discounted wholesale unit gas at the time of purchase+local fees for every locale where the purchaser takes delivery. These charges would be automatically charged to the purchaser's credit account. In this case the discount is applied to the regional wholesale price at the time of purchase.

Another embodiment provides an advantage by allowing purchasers to “pay as they go” and does not require an upfront payment as in the first and second embodiments. Another advantage of the embodiment is that it can be associated with a company sponsored gasoline credit card, for example. Gasoline credit cards are becoming more and more extinct as time goes on. Consumers frequently use universal credit cards, such as, Master Card®; Visa®; Discover®; and American Express® cards that can be also be used for a multitude of retail products and services.

In order to build brand loyalty, these universal credit cards may provide some sort of reward for frequent purchasers based upon the purchases by a customer. In order to attempt to build brand loyalty in a similar way, gasoline retailers, for example, are known to provide rewards in a similar manner. For example, Speedway gas stations in the Midwest offer customers a Speedy Reward card that provides points based upon purchases that can be redeemed for gasoline and other products. Unfortunately, retail gas reward cards, such as the Speedy Reward card, have a significant drawback. In particular, purchasers must insert two cards into the retail gasoline point of purchase device; one for the reward and one for payment. As such, it is cumbersome for those who use such gasoline reward cards that are used to getting reward credit by simply using a universal card for credit, such as a Master Card.

In some embodiments that do not require prepayment, as discussed herein, the commodity discount can be incorporated into a retail gasoline credit card. By incorporating a commodity discount into a retail gasoline credit card, that company will be able to differentiate itself from other gas companies and reverse the current trend of the waning gasoline credit cards. In this embodiment, the commodity purchase card may be brand specific, for example, Exxon®, Shell®, etc. The card could be used for discounted gas and optionally other items. The brand specific card could be used as a conventional brand specific credit card to enable the regional wholesale gasoline price to be discounted and purchased at a point of sale terminal in a conventional manner with the discounts applied to the regional wholesale gas price at the time of purchase.

In some embodiments, the commodity purchase system allows a consumer to pre-purchase a commodity based upon a discounted or undiscounted wholesale price without taking delivery at the time of the purchase. The system takes a snapshot of the wholesale gas prices in the retail sales regions in order to capture the regional wholesale gas prices in the region of interest at the time of purchase of the commodity purchase card. Since the wholesale gasoline prices vary by region, the snapshot of the various regional wholesale gas prices is stored at the time of purchase defining the captured regional wholesale gas price at the time of purchase. The gas price at the time of delivery is then based upon the discounted or undiscounted wholesale gas price at the time the commodity purchase card was purchased. Local taxes and local fees are applied to the discounted or undiscounted wholesale gas price. In this way, a wholesaler can offer a gasoline commodity purchase card with or without a discount that can be used to purchase gas in all regions of a geographical area, such as the US, even though the local taxes, local fees and the regional unit wholesale gasoline price varies. The system determines the location of the user by way of a Point of Sale (POS) terminal. Once the location of the user is known, the system determines a wholesale unit gasoline price at the time of purchase of the commodity card. Next the system subtracts the regional wholesale unit gasoline price at the time of purchase from the retail price to determine the local fees that apply to the location of the POS terminal. Next, the local fees and local taxes are added to the to the discounted or undiscounted unit wholesale gasoline price at the time of purchase to determine a total unit retail price for the location. Once the total unit retail price for the location is determined, the system checks the user's current cash balance and enables the POS pump for a number of gallons as a function of the current cash balance. The commodity purchase system allows a purchaser to purchase a commodity that is attractive to wholesalers without any geographical constraints.

The system may take into account various grades of gas and contemplates various methods for determining a wholesale discount for each of the multiple grades of gasoline, such as, regular (e.g. 87 Octane), mid-range (e.g. 89 Octane) and premium (e.g. 91 octane) and optionally E85 grade. The wholesale discounted or undiscounted prices for these grades may be determined individually by subtracting the wholesale price for each grade at the time of delivery from the retail price per grade at the time of delivery to determine the local taxes and local fees. In such an embodiment, a discount is applied to the wholesale price for that grade at the time of purchase to define a discounted wholesale price for that grade. The local taxes and local fees are added to the discounted or undiscounted wholesale price to determine to determine the discounted or undiscounted retail price.

Alternately, the wholesale price at the time of delivery can be subtracted from the retail price at the time of delivery. Since local taxes can be stored and are known, the taxes can also be subtracted from the difference above to determine the local fees. The wholesale gas price at the POS location at the time of purchase of the commodity purchase card may be discounted or undiscounted defining a wholesale gas price at the locale selected for delivery. In order to determine the retail price at the time of delivery, local fees and local taxes are added to the discounted or undiscounted wholesale gas price. This can be done for each grade.

Alternatively, the discounted or undiscounted wholesale price can be determined for one grade. In this embodiment “differentials” for the other grades can be used to determine the costs for the other grades. These differentials can be in terms of a per cent or dollars. These differentials are determined, for example, by subtracting the retail price of the regular grade from the mid-range or premium grade or by determining the per cent difference between the various grades. In this embodiment a snap shot of current retail gas prices is taken in various locales and stored and used to determine discounted retail prices for mid-range and premium grades.

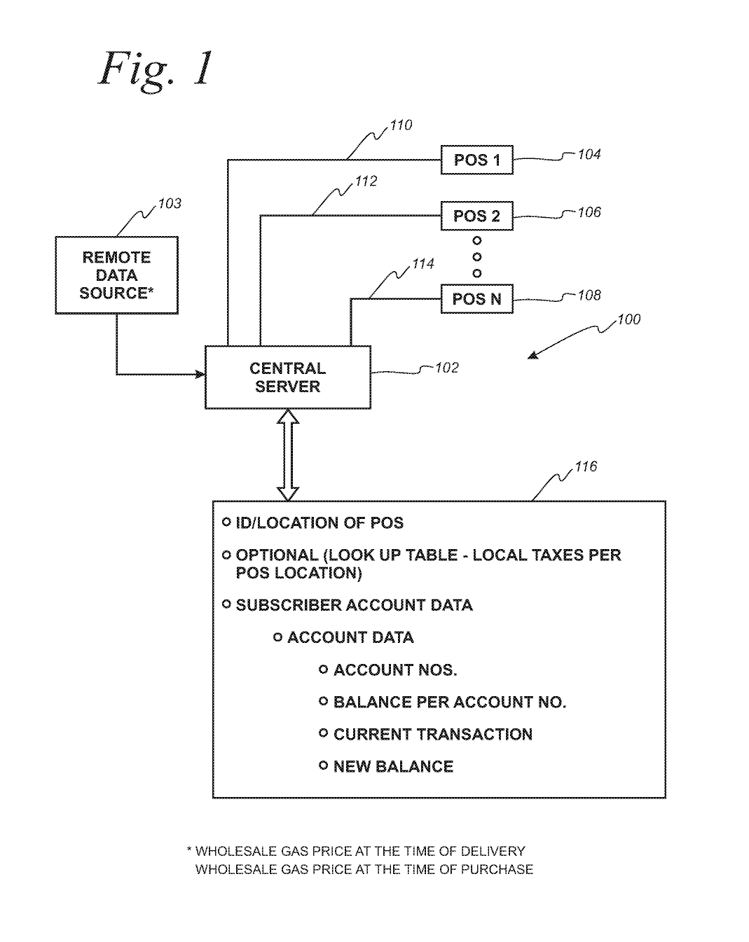

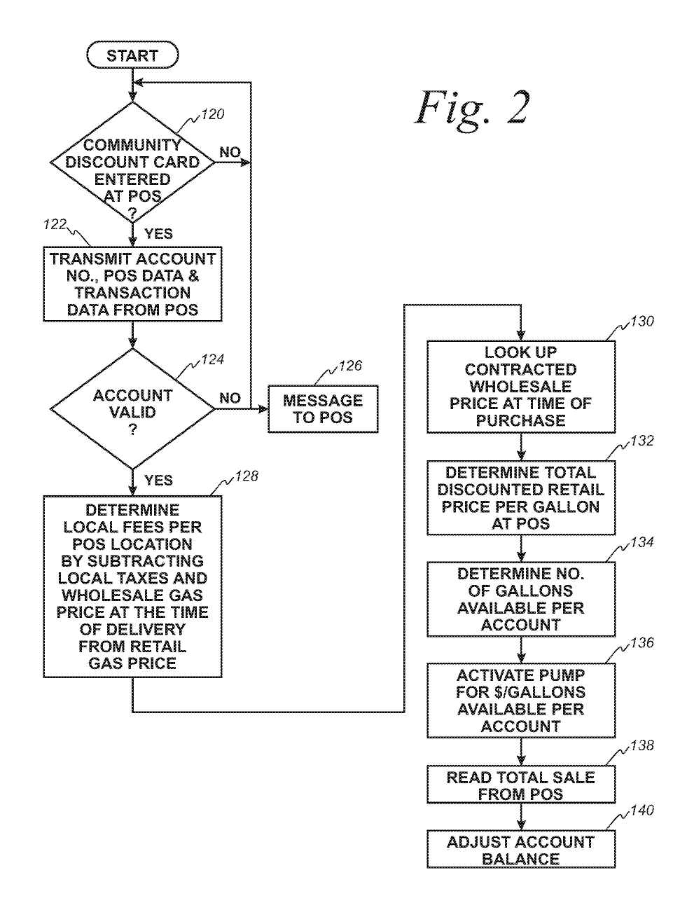

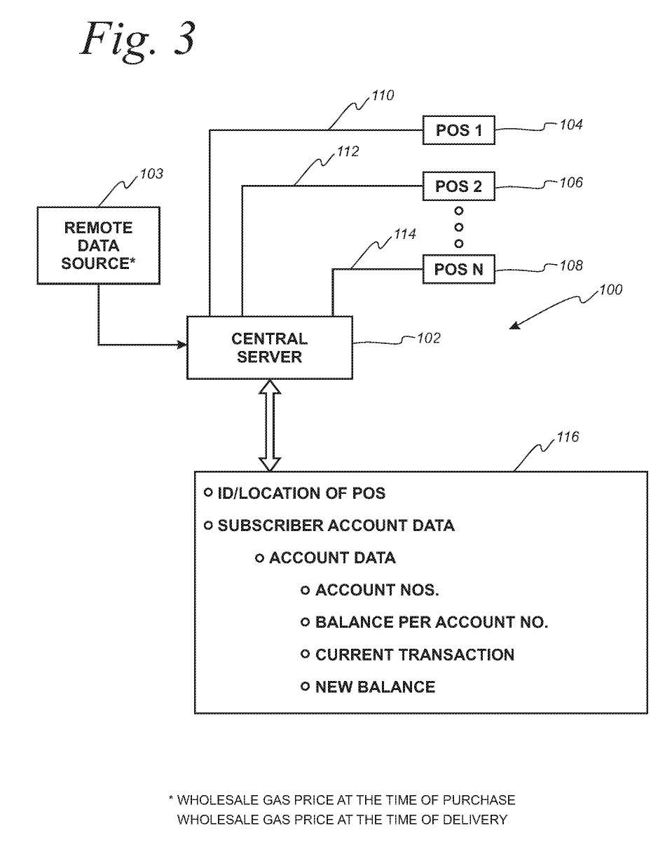

Referring first to FIGS. 1 and 2, an embodiment of the commodity purchase system is illustrated and generally identified with the reference numeral 100. The commodity purchase system 100 may include at least one server 102, for example, a central server, and one or more databases or storage mediums 116. The server 102 may be linked to one or more additional servers (not shown) in a conventional manner in remote geographical areas.

The server 102 is configured to receive point of sale (POS) data from a plurality of retail POS terminals 104, 106 and 108 or alternatively read the data from the discount pass that is either printed or displayed on a smart phone. The retail POS terminals 104, 106 and 108 may be located in different geographical areas, for example, areas in which there is a variance in the local fees and local taxes, as well as differences in regional wholesale unit gasoline prices. The retail POS terminals 104, 106 and 108 may be connected to the central server 102 by way of a plurality of conventional communication links 110, 112 and 114, respectively. The communication links 110, 112 and 114 may be virtually any conventional wired or wireless communication links that enable bi-directional communication between the central server 102 and the POS terminals 104, 106 and 108.

The box 116 illustrates a simplified version of a database or storage medium that is accessible by the server 102. The database 116 may be stored on the server 102 or may be resident on another server that is accessible by the server 102 or may consist of multiple databases. The database 116 or an external data source 103 may include various data, such as local taxes, local fees and the current regional retail gasoline prices at the time of delivery as well as the regional wholesale gas price at the time of delivery as well as the regional wholesale gas price at the time of at the place of delivery at various points in time. The local fees are calculated by the server 102 in one embodiment. In another embodiment, the quantity “local fees +local taxes” is calculated by the server 102.

The retail gasoline prices at the time of delivery, as well as snapshots of the regional wholesale gas prices at the time of purchase of a commodity purchase card is data that is readily available to the gas companies. The database 116 may also include account data. The account data may include the purchaser's account number and the current credit balance.

In this embodiment of the commodity purchase system, purchasers may be provided with magnetic cards or so called chip cards with embedded microchips, for example, similar to conventional credit or debit cards or alternatively, a discount pass with a bar code. The purchaser is able to purchase credit on a commodity purchase card or community purchase pass in a manner that is similar to the method that credit is purchased on gift cards, for example. After credit has been purchased, for example by cash or credit card, the magnetic strip or chip on the commodity purchase card is validated and coded with certain information including the amount of credit associated with the account associated with the card. An account number and vendor associated with the discount may be pre-coded on the magnetic card. Alternatively, such information is coded on a bar code.

As used herein the term “vendor” refers to the issuer of the commodity purchase card which may be the wholesale commodity distributor or a third party. The term validated refers to a commodity purchase card with a balance of the credit stored, either on a storage medium, for example, a database associated with the central server 102. In the latter embodiment, only the purchaser's account number need be stored on the card with the account information stored on the database 116.

Once a commodity purchase card or commodity purchase pass is used for a purchase at a retail gasoline station, for example, the magnetic strip or embedded chip on the purchaser's commodity purchase card may be read by a POS terminal 104, 106 and 108. Alternatively, the bar code may be read by a conventional bar code reader at the POS terminal 104, 106 and 108, The POS terminal 104, 106 and 108 may transmit information from the magnetic strip or embedded chip on the commodity purchase card or the discount pass to the central server 102 which includes an account number and may include the current credit balance in dollars and optionally gallons and the discount price per gallon. Alternatively, the current balance and discount price may be stored on a remote server (not shown) accessible by said server 102.

The POS terminals 104, 106 and 108 additionally transmit representative information to the server 102 regarding the identification and/or location of the POS terminal 104, 106 and 108 where the purchase was made and the amount of purchase including the number of gallons and optionally the date and time of the purchase.

The POS location information enables the central server 102 to access a lookup table that enables the central server 102 to determine the location of the POS terminals 104, 106 and 108 for the purchase. In the embodiment illustrated in FIG. 1, local taxes for various regions are stored. The geographic data from the POS terminals 104, 106 and 108 allows the server 102 to look up the local taxes. The retail price at the time of delivery is provided by the POS terminal 104, 106 and 108. The wholesale unit gasoline price associated with the location of the POS terminal 104, 106 and 108 is received from a remote data source 103. Local fees may be calculated as follows:

Retail price at the time of delivery−regional wholesale price at the time of delivery−local taxes=local fees. [Eq. 1]

Alternatively, the method above may be used to determine the quantity (local fees+local taxes) as indicated below.

Retail price at the time of delivery−regional wholesale price at the time of delivery=(local taxes+local fees). [Eq. 2]

The POS terminals 104, 106 and 108 transmit information to the server 102 that is representative of the location of the POS terminals 104, 106 and the purchaser's account data and optionally the date and/or time of the intended delivery.

Upon receipt of the information from the POS terminals 104, 106 and 108, associated with the purchase, the server 102 optionally looks up the local taxes and calculates the local fees for that region or alternatively calculates the quantity (local fees+local taxes), as discussed above.

The discounted or undiscounted retail gas price at the time of delivery may be based on the discount applied to the captured wholesale unit gasoline price defining a discounted regional wholesale unit price or alternatively based upon an undiscounted captured wholesale unit gasoline price. As discussed above, the captured wholesale regional wholesale price is the regional wholesale price at the time of purchase of the commodity purchase card. Local fees and local taxes per gallon are added to the discounted or undiscounted regional wholesale unit price in order to arrive at a discounted or undiscounted retail gasoline price per gallon. Based upon the purchaser's available account balance or available credit, the central server 102 determines the number of gallons that can be dispensed to the purchaser at the current POS terminal 104, 106 or 108.

In addition to determining the discounted or undiscounted retail gas price per gallon and before authorizing the dispensing of gasoline i.e. turning the gasoline pump on, the system determines if the purchaser's account has been validated and that there is credit balance available. If either the account is not valid or the card has a zero credit balance, the central server 102 does not send a signal to the POS terminal 104, 106 and 108 to turn the pumps on, or alternatively sends a signal to maintain the pump off, and may send a message, such as “Account Not Valid” to the POS terminal 104, 106 and 108. If the purchaser's account is valid and includes a credit balance, the central server 102 sends a signal back to the POS terminal 104, 106 and 108 over one of the bidirectional communication links 110, 112 and 114, respectively, to turn the pump on for the number of gallons equivalent to the purchaser's current balance at the discounted or undiscounted price per gallon. The central server 102 monitors the number of gallons being dispensed to the purchaser and will signal the pump to turn off once the gallon or dollar limit of the purchaser's account is at the purchaser's credit limit.

After the gasoline dispensing is terminated either by the purchaser or automatically when the purchaser's gas tank is full, the POS terminal 104, 106 and 108 may send a signal back to the central server 102 that the sale is concluded. Upon receipt of that signal, the central server 102 adjusts the purchaser's account balance. Both the dollar amount and the remaining number of gallons may be adjusted. These revised balances are stored by the central server 102 or alternatively stored at a remote server (not shown) accessible by the central server 102.

A simplified flow chart is illustrated in FIG. 2 It is to be understood that the commodity discount system is not limited to the sequence of steps set forth in FIG. 2. The process may be executed in different sequences in order to reach the end results, discussed above.

Since the commodity purchase card can be used at retail gasoline stations, various credit cards in addition to the commodity purchase card will be used to purchase gasoline. As such, the system waits in step 120 for a commodity purchase card to be swiped at a POS terminal 104, 106 and 108. Once a magnetic strip or an embedded chip on a commodity purchase card is read by a POS terminal 104, 106 or 108, the purchaser account number from the commodity purchase card is read by the POS terminal 104, 106 and 108. The purchaser account number along with the transaction data is sent to the central server 102 in step 122. The system then determines if the purchaser balance is valid in step 124. If the account is not valid, the system returns to step 120 and waits for another commodity purchase card to be swiped at the POS terminal 104, 106 and 108. In this situation, a message, such as “Account Not Valid”, may optionally be returned to the POS terminal 104, 106 and 108, as indicated in step 126.

If the purchaser's account is valid, the system will read POS data from the POS terminal 104, 106 and 108 to determine the geographic location of the POS terminal 104, 106 and 108 in order to look up the local taxes and calculate local fees, as discussed above, as indicated in step 128 or alternatively calculate the quantity local fees+local taxes. In step 130, the server 102 looks up the captured wholesale price per gallon at the time of purchase for the specific region in which the POS terminal is located and uses that price when calculating the discounted retail price at the time of delivery and optionally the number of gallons available in the purchaser's account in steps 130 and 132.

The captured wholesale price at the time of purchase is the wholesale regional price at the time the commodity purchase card was purchased. This price is the price that may be discounted at the time of delivery. In step 132, the server 102 determines the total discounted or undiscounted unit gasoline price per gallon, i.e. discounted or undiscounted retail price, which is the sum of the discounted regional wholesale unit gasoline price per gallon and the local fees and local taxes per gallon. In step 134, the server 102 determines the number of gallons that can be purchased based upon the total discounted or undiscounted unit gasoline price per gallon and the amount of money and optionally the number of gallons in the purchaser's account. In step 136, the server 102 signals the pump at the POS terminal to turn on. Once the pump is turned on, the central server 102 may optionally provide signals to the POS terminal 104, 106 and 108 to display the adjusted price per gallon and the total prices at the adjusted price. The POS terminal will allow the pump to stay on up to the limit of the purchaser's dollar amount or optionally a number of gallon limit. Once the pumped gas reaches either limit, the server 102 sends a signal to the POS terminal to turn it off. Alternatively, as discussed above, the pump may be turned off at the POS terminal 104, 106 and 108 either manually by the purchaser or automatically when the purchaser's gas tank is full.

The total number of gallons dispensed is transmitted from the POS terminal 104, 106 or 108 to the central server 102 in step 138. The central server 102 determines the total cost of the purchase as follows:

(total discounted unit gasoline price per gallon+local fees+local taxes) times the number of gallons dispensed=total cost of the purchase.

In step 140, the purchaser's account is adjusted and stored as an account balance by the server 102. Both the dollar amount and optionally the number of gallons are adjusted.

The alternate embodiments of the commodity purchase system, mentioned above, are similar to FIGS. 1 and 2. The only difference between the various embodiments is in FIG. 2, block 136. In particular, one embodiment is based upon a fixed amount of cash. More specifically, in this embodiment, the purchaser purchases a commodity purchase card or commodity purchase pass that allows the purchaser to purchase an unspecified number of units of the commodity up to a fixed cash value, for example as illustrated above. In this embodiment, the pump would only be activated for a fixed dollar amount based upon the current balance in the purchaser's account. In another alternate embodiment, the pump would only be activated for a fixed number of gallons based upon the available number of gallons in the purchaser's account.

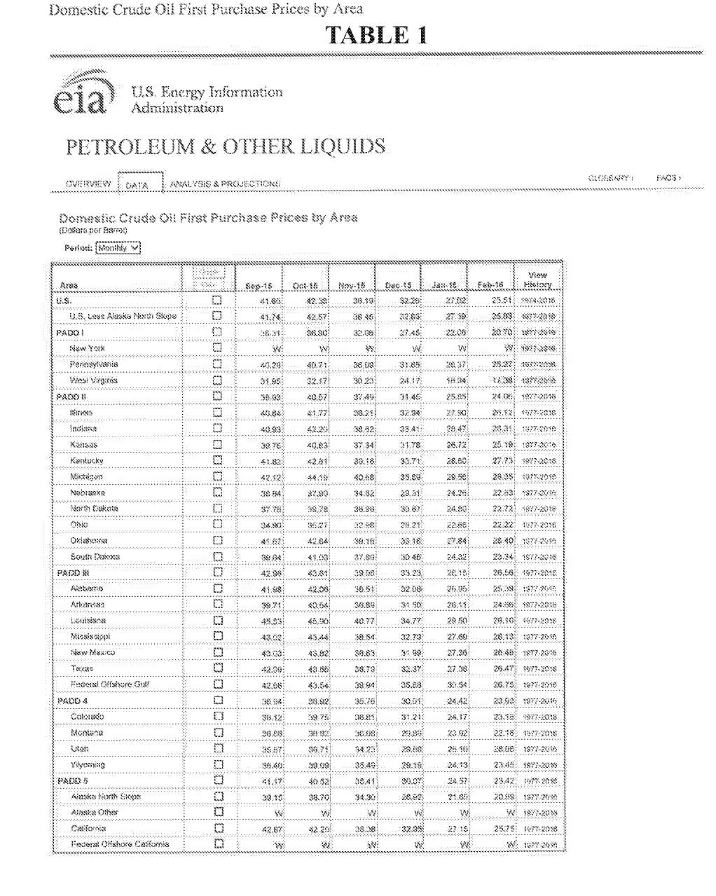

In another alternate embodiment, as illustrated in FIG. 3, the wholesale gas price at the time of delivery and the wholesale gas price at the time of sale is received from the remote data source 103. In this embodiment, the discounted or undiscounted retail gas price at the time of delivery is determined as follows:

undiscounted retail gas price at time of delivery−wholesale price at the time of delivery=local taxes+local fees

discounted or undiscounted retail price at the time of delivery=discounted or undiscounted wholesale price at the time of purchase+local taxes+local fees

In yet another embodiment, there is no need to keep track of local taxes and local fees. The system need only keep track of the discounted or undiscounted wholesale price at the time of purchase and the undiscounted retail price at the time of delivery for the specific POS location. The wholesale price at the time of purchase is a snap shot of a plurality or all of the various wholesale prices in the region of interest at the time the commodity purchase card is purchased. In other words, a plurality or all of the wholesale gas prices are frozen at the time of purchase. For example, if a purchaser purchases a purchase card in Chicago and uses the card in Texas, the undiscounted wholesale price at the time of purchase will be the wholesale price at a locale in Texas at the time of purchase of the commodity purchase card. If the purchaser then purchases gas in Tennessee, the wholesale price of gas at the time purchase will be the whole sale price in Tennessee at the time the when the commodity was purchased. These wholesale gas prices at the time of purchase are used in the calculations mentioned above. Discounts are applied to regional wholesale prices at the time of purchase of the commodity purchase card.

In other embodiments, the commodity purchase card is not prepaid. In such embodiments, the gas pump is under the control of the POS terminal and allows the pump to be turned on by the purchaser. The pump may be turned off by the purchaser or automatically when the tank is full or when the transaction is completed.

In such embodiments, the discount may be in terms of a per cent or a cash discount on the wholesale gas price at the time of purchase at the place of delivery. The wholesale gas price data all across a region would be readily available to a gasoline company. In this case, the system would receive the location data from the POS terminal. That information would be used to determine the wholesale gas price for the location where the gas is being delivered. The discount for the location is determined. For example, if the wholesale gas price for the region is $2.00 per gallon and the gas company is offering a 10% discount on the wholesale price, the discount would amount to $0.20 per gallon. This discount would then be subtracted from the retail price at the location where the gas is being delivered. Assuming the local taxes and local fees are $1.00 per gallon, the discounted price would be $2.80 per gallon. In another region where the wholesale gas price is $1.80 per gallon, a 10% would amount to $0.18 per gallon. This $0.18 per gallon would then be deducted from the retail price at the time of delivery. Assuming the local taxes and local fees are $1.00 per gallon, the discounted price would be $2.62 per gallon.

In the examples above, a 10% discount can be uniformly applied in regions where the wholesale gas price in those regions varies. As such, the commodity card enables a gasoline company or other commodity supplier to offer a uniform discount all across its service region even though the wholesale gas prices vary across the region. The discount may be uniform across an entire region, such as the US. However, it is also contemplated that there may be some circumstances where it makes sense vary the discount across a region. It is also contemplated that the discount can only be valid for a specified period of time, for example, a month.

A second embodiment of a commodity purchase card system that does not require prepayment is described below. This embodiment allows a gasoline company to offer a uniform discount on its wholesale gas price even though the prices vary in different regions. A commodity purchase system, similar to the systems discussed above, utilizes a gasoline credit or debit card for purchase of a commodity. In this system, rather than check the cash balance of the prepaid card, as discussed above, the system checks the available credit on the credit card or cash available on the debit card account. The system applies a discount to the wholesale price at the time of delivery, in a similar manner as discussed above. The pump is enabled up to the credit limit of the credit card or the available cash accessible by the debit card.

In particular, this embodiment relates to a commodity purchase system for use with a gasoline credit or debit card for enabling a commodity, e.g. gasoline to be pumped and debited to the account of said gasoline credit or debit card at a discounted regional unit price. The discounted regional price is based in part upon a uniform discounted regional wholesale gas price taking into account local taxes and local fees and the regional wholesale gas price for the location where the gas is to be delivered.

The system includes a server for receiving information from POS terminals from a gasoline credit or debit card. The information includes at least the purchaser's credit or debit card account numbers as well as the location of the POS terminal. The data is stored in a storage medium which may include a look up table for storing the local taxes and local fees based upon the location of the POS terminal. In this embodiment, the server is configured to determine the per unit local fees and local taxes based upon the location of the POS terminal as well as the regional unit wholesale gasoline price at the time of purchase and at the time of delivery and to use those prices to determine the discounted retail price. The server is further configured to turn on the gas pump and debit the purchaser's credit or debit account for the amount of gas pumped and turn off the pump once the transaction is finished. The discount may be determined by applying a discount to the regional wholesale price and subtract the result from the regional retail price.

The principles of the invention are equally applicable to various regions, including regions outside of the US. For example, the principles of the invention are applicable to Europe as well as other regions outside of the US.

Although the principles of the invention are applicable to various types of commodities, as discussed above, the commodity discount system is described and illustrated below with respect to gasoline. For example, the commodity purchase system can be implemented with both energy-related commodities and non-energy related commodities.

Obviously, many modifications and variations of the present invention are possible in light of the above teachings. Thus, it is to be understood that, within the scope of the appended claims, the invention may be practiced otherwise than as specifically described above.

1. In a system comprising a Point of Sale (POS) terminal and a server, a method for operating a said POS terminal in multiple geographic locations with a commodity card based upon a dollar value that enables gasoline to be purchased at a discounted retail price for later delivery at a price based upon a wholesale gas price existing at the location of the POS terminal at delivery at the time of purchase of the commodity card, the commodity card having an initial prepaid cash value in dollars for enabling a pump to be controlled by the a POS terminal up to the current cash value of the commodity card, the method comprising the steps of:
(a) enabling at least purchaser's account number data from said commodity card to be read at said POS terminal;
(b) enabling POS data including at least the location of the POS terminal and the purchaser's account number as well as the current cash value in the purchaser's account, the undiscounted wholesale gas price, the undiscounted retail gas prices at the POS terminal at the time of delivery and the discounted wholesale gas price at the time of purchase of the gas card to be stored on a storage medium;
(c) automatically determining the maximum number of units of gas that can be pumped at said POS terminal at the location where said POS terminal is located in response to said commodity card being read at said POS terminal by determining the discounted unit retail price at the time of delivery to be the undiscounted retail pump price at the location of delivery minus the undiscounted wholesale price at the time of delivery plus the discounted wholesale unit price at the location of delivery at a discount set at the time of purchase of the commodity card and using the discounted retail gas price and the current cash balance of the commodity card in order to determine the maximum number of units:
(d) automatically enabling a pump at said POS terminal for said maximum number of units of said commodity determined in step (c) to allow gas to be pumped; and
(e) automatically debiting the discounted retail gas price times the number of units pumped from the current cash value of purchaser's account in a single transaction.

2. The method as recited in claim 1, wherein said predetermined commodity is an energy related commodity.

3. The method as recited in claim 1, wherein said predetermined commodity is a non-energy related commodity.

4. The method as recited in claim 2, wherein said predetermined commodity is gasoline.

5. The method as recited in claim 1, wherein step (a) includes the step of reading a magnetic strip or embedded chip at said point of sale (POS) terminals in a similar manner as a conventional credit card.

6. A computerized prepaid cash card system for use with a prepaid cash card having a cash value for enabling a commodity to be pumped and debited from said prepaid cash card at a discounted retail unit price at the time of delivery that is based upon a discounted wholesale unit gas price at the time said prepaid gas card is purchased, the prepaid cash card system configured to be used at POS terminals in multiple geographical regions, each POS terminal comprising:
a server for receiving data from said POS terminals when said prepaid cash card coded with at least the purchaser's account number is received at the POS terminal for pumping said commodity, said data including at least the purchaser's account number as well as the location of the POS terminal;
a storage medium for storing at least purchaser account data including the purchaser's account number and, the current cash value in the account associated with the purchaser's prepaid cash card and a snap shot of a plurality of unit wholesale gas prices at the time of purchase of the commodity discount card in a plurality of locations in which the unit wholesale gas price varies including the wholesale price at the POS terminal where the gas is delivered at a time when the prepaid gas card is purchased as well as the undiscounted unit retail price and the undiscounted unit wholesale price at the time of delivery;
wherein said server includes means for determining the discounted retail unit gas price at the location where the gas is being delivered based upon a the unit retail gas price at the time of delivery minus the unit wholesale gasoline price at the time of delivery plus the discounted wholesale price at a discount set at the time of purchase of the prepaid gas card and to use that price to determine the maximum number of discounted units of the commodity that can be pumped based upon a current cash value of the purchaser's account in a single transaction.

7. The computerized cash card system as recited in claim 6, wherein said server is configured to enable costs for items other than said predetermined commodity to be debited to purchaser's account and to take into account the cost of such items when determining the maximum amount of the commodity that can be purchased.

8-9. (canceled)
